(19) United States
(12) Patent Application Publication
(10) Pub. No.: US 2007/0245849 A1
(43) Pub. Date: Oct. 25, 2007

(54) Structure for fixing seat of auxiliary handlebar of bicycle

(75) Inventor: Chun-Feng Chen, Taichung Hsien (TW)

Correspondence Address: TROXELL LAW OFFICE PLLC, SUITE 1404, 5205 LEESBURG PIKE, FALLS CHURCH, VA, 22041, US

(73) Assignee: Ourway Engineering Co., Ltd.

(21) Appl. No.: 11/650,589

(22) Filed: Jan. 8, 2007

(30) Foreign Application Priority Data
Jan. 10, 2006 (CN) 200620000632.9

(51) Int. Cl. B62K 21/12

(52) U.S. Cl. 74/551.8

(57) ABSTRACT

An improved structure for fixing seat of auxiliary handlebar of bicycle, which is comprised by auxiliary handlebar and fixing seat combined with end of auxiliary handlebar; wherein fixing seat is composed of upper fixing seat and lower fixing seat, bottom of upper fixing seat is set as arc groove and top of lower fixing seat is set as arc groove, which form a round groove to cover handlebar of bicycle, key features of this invention are as follows: an upper semicircle position column is set at front end of upper fixing seat approaching auxiliary handlebar, and a vertical screw is set at its end, meanwhile, a lower semicircle position protruding column is set at front end of lower fixing seat approaching end of auxiliary handlebar and its end also set a vertical screw, so, after upper and lower fixing seat are covered onto handlebar of bicycle, end of auxiliary handlebar can be directly covered into outer rim of position protruding column formed by frond ends of upper and lower fixing seat, and then put a single bolt into screws set at ends of upper and lower fixing seat to lock up auxiliary handlebar and fixing seat into one entity basing on the lever principle of applied mechanics, therefore, the assemble is very convenient.

### BACKGROUND OF THE INVENTION

1) Field of the Invention

This invention relates to an improved structure for fixing seat of auxiliary handlebar of bicycle, which is related with auxiliary handlebar fixed at front end of middle section of bicycle's handlebar, to be more specific, the improved structure is to let the assembly be more convenient and reduce assembly cost as well when fixing auxiliary handlebar with bicycle's handlebar.

2) Description of the Prior Art

Fixing seat of bicycle's auxiliary handlebar of the prior art, please refer to FIG. 1, FIG. 2 and FIG. 3, is comprised by tube-made auxiliary handlebar 2 and fixing seat 3 covered onto end 21 of auxiliary handlebar2; wherein fixing seat 3 is composed of upper fixing seat 31 and lower fixing seat 32, bottom of upper fixing seat 31 is made as arc groove 311, and vertical screw 312 is respectively set at its front and rear end, arc groove 321 is also made at top of lower fixing seat 32, vertical screw 322 is also respectively set at its front and rear end, its bottom is made a round seat 323, through hole 324 is made in front of round seat 323, so that end 21 of auxiliary handlebar 2 can pass through the through hole 324, then cover decoration cap 325 can cover onto end of auxiliary handlebar 2, cut 326 is made at outside of through hole 324, vertical screw 327 is made at bottom of cut 326 so as to let bolt 328 pass through for locking.

If want to fix auxiliary handlebar 2 with bicycle's handlebar 4, let upper fixing seat 31 of fixing seat 3 on middle top of handlebar 4 aim at its lower fixing seat 32 below handlebar 4, so that screws 312,322 made at front and rear end of upper and lower fixing seat 31 and 32 can aim at each other, then, arc groove 311 at bottom of upper fixing seat 31 can cover handlebar 4 with round groove of arc groove 321 at top of lower fixing seat 32 (as shown in FIG. 3), so, upper and lower fixing seat 31,32 of fixing seat 3 can be fixed at middle section of handlebar 4 with bolts 33 as show in FIG. 2); then put end of auxiliary handlebar 2 into through hole 324 of round seat 323 at bottom of lower fixing seat 32, and cover decoration cap 325 onto tube-made end of auxiliary handlebar 2, finally, put bolt 328 through the through hole 324 to screw 327 at bottom of outside cut 326 so as to lock up end of auxiliary handlebar 2 with round seat 323, thus, auxiliary handlebar 2 can be fixed at middle section of bicycle's handlebar 4.

However, in above said structure, if want to fix upper and lower fixing seat 31,32 of fixing seat 3 with bicycle's handlebar 4, must first let screw 312,322 made at front and rear ends of upper and lower fixing seat 31,32 aim at each other, and then put bolt 33 through screw 312,322, thus, upper and lower fixing seat 31 and 32 of fixing seat 3 can be locked at middle section of handlebar 4; furthermore, it is required to set a round seat 323 at bottom of lower fixing seat 32 and to make through hole at round seat 323, besides, a cut 326 must be set at outside of through hole 324, so that end of auxiliary handlebar 2 can pass through the through hole 324, decoration cap 325 is covered onto end of auxiliary handlebar 2, finally, put bolt 328 through screw 327 so as to lock up end of auxiliary handlebar 2 with round seat 323, therefore, must lock up three points with three bolts 33,328 when assembling end of auxiliary handlebar 2 with fixing seat 3 and handlebar 4, thus, such assembly is complicated and wastes time, the manufacturing and assembly costs are also increased, so, it is required to get improved.

### SUMMARY OF THE INVENTION

In order to improve above said disadvantages of structure, this invention provides an improved structure for fixing seat of bicycle's auxiliary handlebar, which is comprised by auxiliary handlebar and fixing seat combined with end of auxiliary handlebar; wherein fixing seat is composed of upper and lower fixing seats, bottom of upper fixing seat and top of lower fixing seat have arc grooves which form a round groove to cover handlebar of bicycle, its features are as follows: an upper semicircle position protruding column is set in the front of fixing seat approaching end of auxiliary handlebar, and its end is set as vertical screw, meanwhile, a lower semicircle position protruding column is set in the front of fixing seat approaching end of auxiliary handlebar, and its end is set as vertical screw, so that end of auxiliary handlebar can be directly covered into the outer rim of round position protruding column combined by front ends of upper and lower fixing seats after upper and lower fixing seats covered onto handlebar of bicycle, then directly screw up screws at ends of upper and lower fixing seats with one bolt, thus, basing on lever principle of applied mechanics, lock up auxiliary handlebar, fixing seat and handlebar of bicycle into one entity, so that such structure is easy to assemble.

### BRIEF DESCRIPTIONS OF DRAWINGS

FIG. 1 is the exploded view of the prior art.

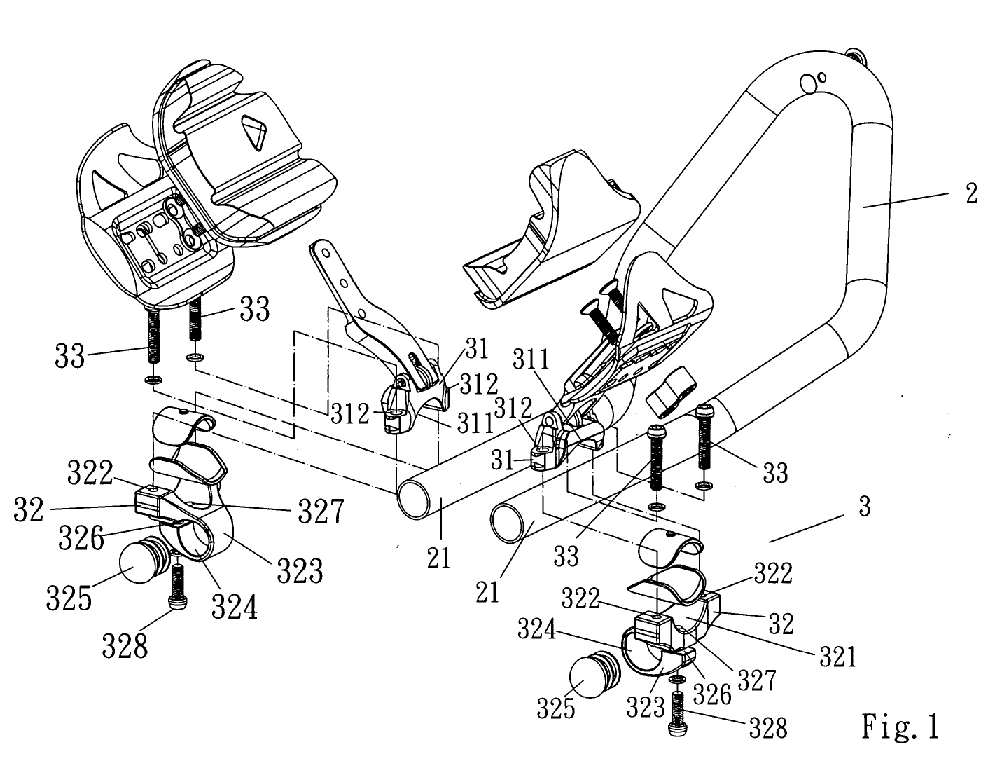

FIG. 2 is the exploded combination view of the prior art.

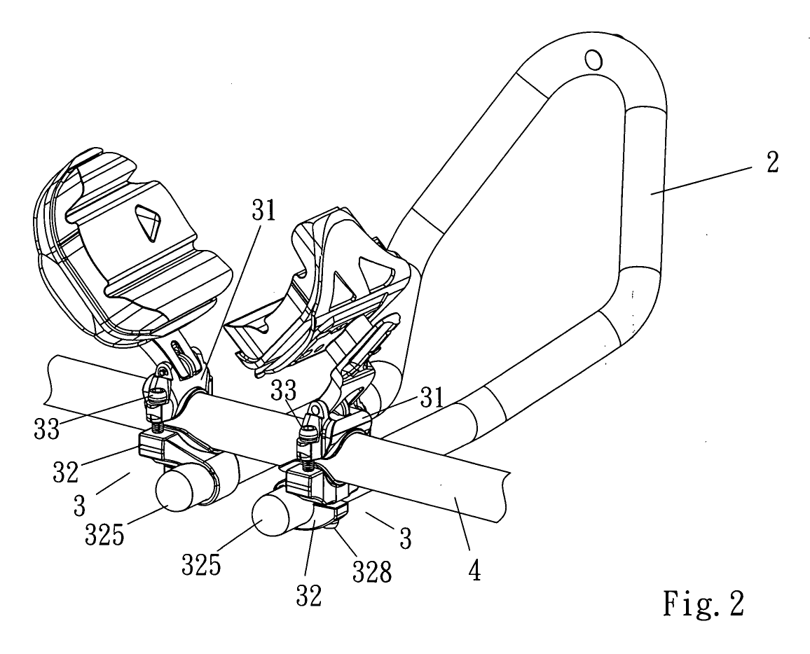

FIG. 3 is the section view (side-glance) of the prior art.

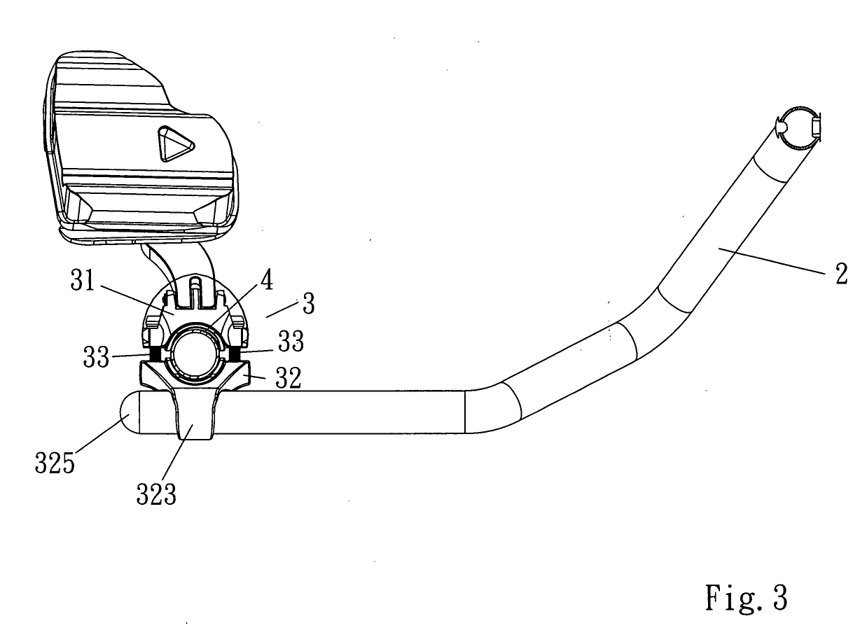

FIG. 4 is the exploded view of this invention.

FIG. 5 is the exploded combination view of this invention.

FIG. 6 is the appearance (side-glance) of structure of this invention.

FIG. 7 is the section view of this invention.

### DETAILED DESCRIPTION OF THE PREFERRED EMBODIMENTS

We hereby describe structure features of this invention with drawings in the following for your reference.

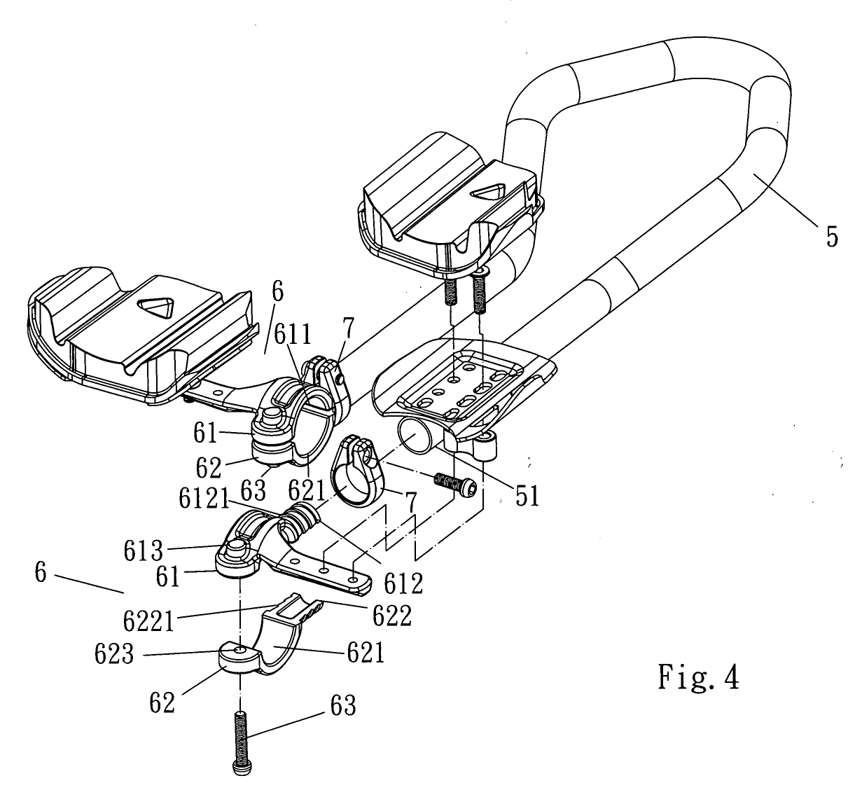

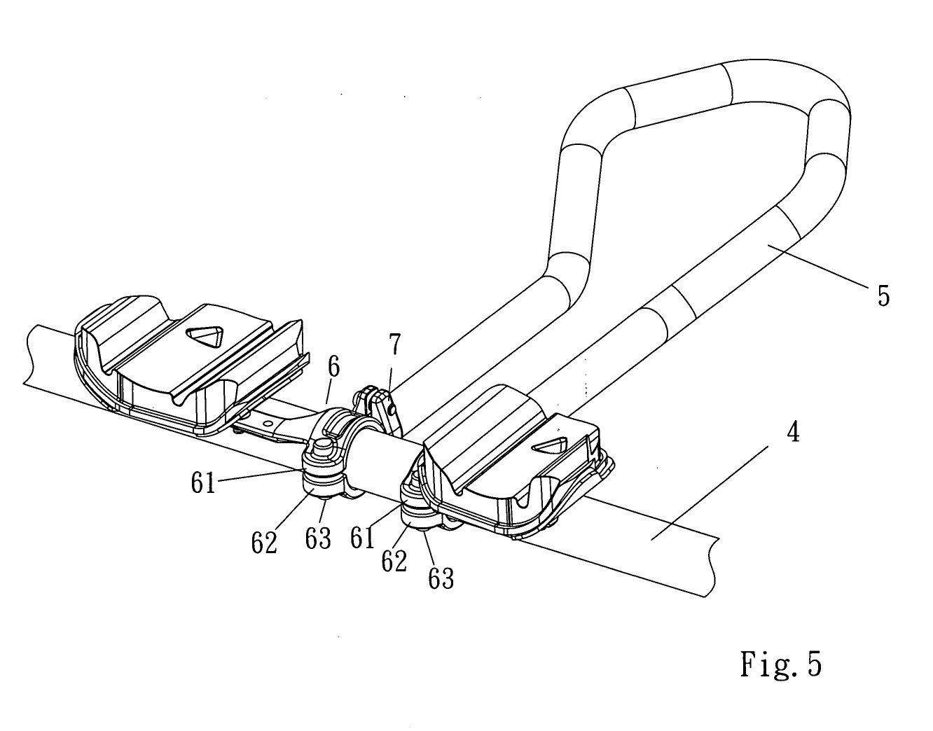

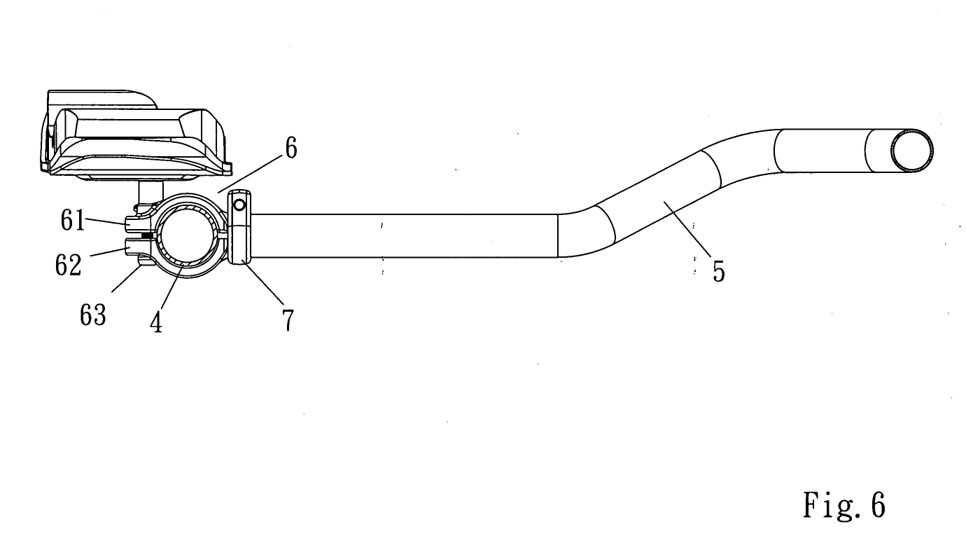

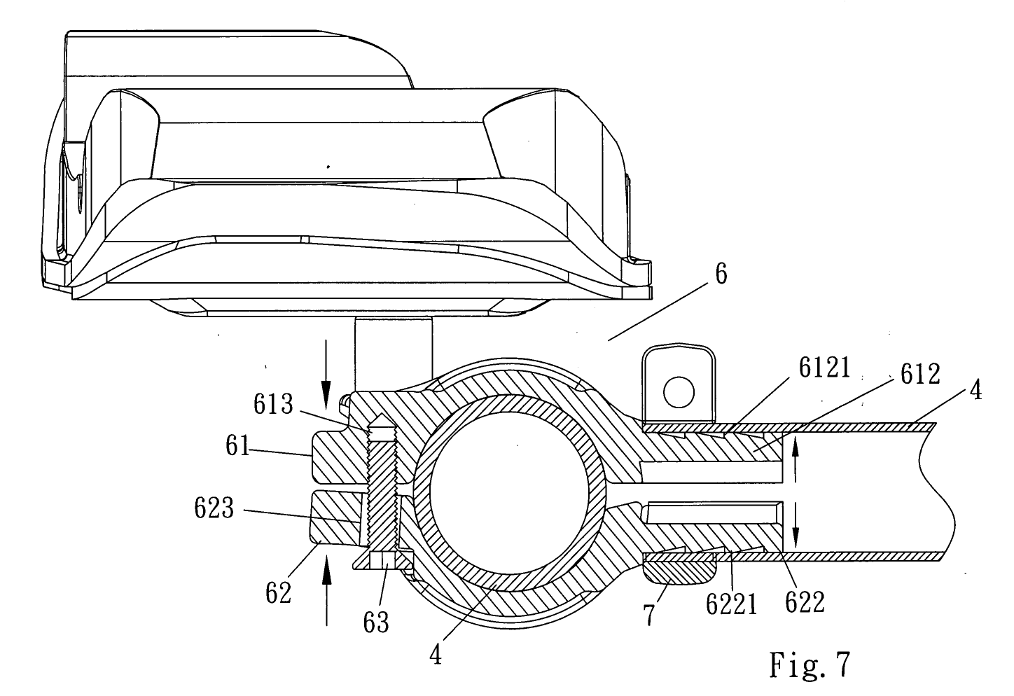

Please refer to FIG. 4,FIG. 5,FIG. 6 and FIG. 7, fixing seat of auxiliary handlebar is comprised by auxiliary handlebar 5 and fixing seat 6 combined with end 51 of auxiliary handlebar 5; wherein fixing seat 6 is composed of upper fixing seat 61 and lower fixing seat 62, bottom of upper fixing seat 61 is set as arc groove 611, and top of lower fixing seat 62 is set as arc groove 621, which form a round groove to cover handlebar 4 of bicycle, key features of this invention are as follows: a vertical screw 613 is set at end of upper column 612, an upper semicircle position protruding column 622 is set in the front of fixing seat 62 approaching end 51 of auxiliary handlebar 5, so that upper and lower fixing seat can form a round protruding column, meanwhile, a vertical screw 623 is also set opposite to its end and vertical screw 613 set at end of fixing seat 61.

Basing on above said structure, if want to combine auxiliary handlebar5 with handlebar 4, just let upper fixing seat 61 of fixing seat 6 at middle top of handlebar 4 aim at lower fixing seat 62 below handlebar 4, meanwhile, screws 613,623 set at rear ends of upper and lower fixing seat 61,62 aim at each other, so that the round groove formed by arc groove 611 set at bottom of upper fixing seat 61 and arc groove 621 set at top of fixing seat 62 cover onto handlebar 4 of bicycle (as show in FIG. 5), again please see FIG. 7, it can be directly covered into end 51 of tube-made auxiliary handlebar5, and then upper semicircle position protruding column 612 set at front end of upper fixing seat 61 and lower semicircle position protruding column 622 set at front end of lower fixing seat 61 approaching auxiliary handlebar 5 can form a round protruding column, so, put bolt 63 through screws 613,623 set at rear end of upper and lower fixing seat 61,62 to lock up accordingly; in accordance with the lever principle of applied mechanics, after round groove formed by arc groove set at bottom of upper fixing seat 61 and arc groove seat at top of lower fixing seat 62 covers onto handlebar 4 of bicycle, upper and lower fixing seat 61,62 take handlebar of bicycle as fulcrum, so, as ends of upper and lower fixing seat 61,62, due to rotation of bolt 63, are locked up in opposite direction, position protruding column 612 and 622 at front end of upper and lower fixing seat 61,62 are pressed outward in opposite direction so as to press inner of end 51 of auxiliary handlebar 5, thus, only one bolt 63 can lock up fixing seat 6 comprised by upper and lower fixing seat 61,62 at middle section of handlebar 4, meanwhile, such bolt can also fix fixing seat 6 and auxiliary handlebar 5, therefore, the assembly is convenient and save time as well.

In addition, please refer to FIG. 4 and FIG. 7, make position teeth 6121, 6221 at semicircle ring of position protruding column set at front ends of upper and lower fixing seat 61,62, as end 51 of auxiliary handlebar 5 is covered into upper semicircle position column 612 set at front end of upper fixing seat 61, which forms round column with lower semicircle position column 622 set at front end of lower fixing seat 62 approaching auxiliary handlebar5, position column 612 and 622 form a round column, thus, as you rotate bolt 63 outward, end 51 of auxiliary handlebar 5 can be further tightened.

Please once again refer to FIG. 4, FIG. 5 and FIG. 7, fixing cap 7 can be locked at outer rim of end 51 of auxiliary handlebar 5 so as to let end 51 of auxiliary handlebar 5 cover into position column 612 set at front end of upper fixing seat 61, which forms round protruding column with position protruding column 612 set at front end of lower fixing seat approaching auxiliary handlebar 5, thus, as you rotate bolt 63 to tighten position protruding column 612 and 622 set at front ends of upper and lower fixing seat 61, 62 outward, outer rim of end 51 of auxiliary handlebar 5 can be tightened by another lock structure.

To sum up all above descriptions, the improved structure can overcome disadvantages of product in the same line, which has never-been published in any public magazine, so, it is in accordance with requirements of a new patent.

What is claimed is:

1. An improved structure for fixing seat of auxiliary handlebar of bicycle, which is comprised by auxiliary handlebar and fixing seat combined with end of auxiliary handlebar; wherein fixing seat is composed of upper fixing seat and lower fixing seat, bottom of upper fixing seat is set as arc groove and top of lower fixing seat is set as arc groove, which form a round groove to cover handlebar of bicycle, key features of this invention are as follows: an upper semicircle position column is set at front end of upper fixing seat approaching auxiliary handlebar, and a vertical screw is set at its end, meanwhile, a lower semicircle position protruding column is set at front end of lower fixing seat approaching end of auxiliary handlebar, so that upper fixing seat and lower fixing seat can form a round protruding column, meanwhile, a vertical screw is also set at the corresponding position to its end, therefore, basing on the lever principle of applied mechanics, a single bolt can lock up auxiliary handlebar and the fixing seat.

2. The improved structure of claim 1 wherein said position protruding column set at front end of upper and lower fixing seat can make semicircle ring-shaped position teeth.

3. The improved structure of claim 1 wherein said end of auxiliary handlebar can lock a fixing cap.
